(19) United States
(12) Patent Application Publication
(10) Pub. No.: US 2024/0410334 A1
(43) Pub. Date: Dec. 12, 2024

(54) MOTOR BLADE GENERATOR SYSTEM

(71) Applicant: Donald Lee Adle, Clearwater, FL (US)

(72) Inventor: DONALD LEE ADLE, Clearwater, FL (US)

(21) Appl. No.: 18/206,606

(22) Filed: Jun. 6, 2023

(51) Int. Cl. F03D 9/25; H02K 7/18; H02K 11/00

(52) U.S. Cl. CPC F03D 9/25; H02K 7/1823; H02K 11/0094; F05D 2220/76

(57) ABSTRACT

A method for using a motor using a convergent-divergent choked nozzle. Nozzle being a component of blade with rotation system. Nozzle to transmit power movement to blade. Blade to transmit power movement to generator. Generator with means to generate electricity.

### REFERENCE TO MICROFICHE APPENDIX

Not applicable.

### STATEMENT REGARDING FEDERALLY SPONSORED RESEARCH OR DEVELOPMENT

Not applicable.

### CROSS-REFERENCE TO RELATED APPLICATIONS

Not applicable.

### INDUSTRIAL APPLICABILITY

Motor blade generator system; method to generate electricity, direct current (DC) or alternation current (AC). A non-polluting system producing electrical power required for all kinds of: Aircrafts, Automobiles, Buildings, Machines, Ships, Trains, Vehicles. Meeting all requirements by any regulatory body and in accordance with any regulations that impact the polluting of the air industry.

### BACKGROUND

Battery 2 is a source of electric power consisting of one or more electrochemical cells with external connections for powering electrical devices. Battery 2 its positive terminal is the cathode, and its negative terminal is the anode supplying power to motor 4. Motor 4 that develops energy or imparts motion to motor axis 6. Motor axis 6 rotating axis that transforms rotating mechanical energy to blade 10 also known as propeller.

The blade 10 is shaped much like a wing of an aircraft, using the rotation power of motor axis 6 with means that are joined to blade 10 rotating. Permit incoming ambient downstream air to increase kinetic energy within compressor nozzle 12. Blade 10 uses compressor nozzle 12 to increase kinetic energy. Permit incoming ambient downstream air to increase kinetic energy within compressor nozzle 12 giving blade 10 that transforms rotating energy. Blade 10 transforms rotating energy to generator axis 14 rotating that transforms rotating mechanical energy to generator 16.

### INFORMATION

Blade 10 also known as propeller. Most blade 10 use a variable pitch mechanism to alter the blade 10 pitch angle as giving speed velocity. A further consideration is the number and the shape of the blade 10 used. Increasing the aspect ratio of the blade 10 reduces drag but the amount of thrust produced depends on blade 10 area, so using high-aspect blades 10 can result increasing the ratio pressor within container 8 diameter increasing ratio within compressor nozzle 12. A further balance is that using a smaller number of blades 10 reduces interference effects, but to have sufficient blade 10 area to transmit the available power within a set diameter means a compromise is needed. Increasing the numbers of compressor nozzle 12 decreases the amount of work blade 10 is required to perform. Compressor nozzles 12 decreases the amount of work motor 4 is required to perform. Compressor nozzle 12 transmits the available power within a set diameter to blade 10 giving speed velocity. Increasing the number of compressor nozzles 12 increases the amount of work generator axis 14 to be able to perform. Generator axis 14 increases the amount of work generator 16 to be able to perform.

Compressor nozzle 12 having one is a tube that is pinched in the middle, making an a carefully balanced, asymmetric shape. Compressor nozzle 12 at the throat, where the cross-sectional area is at its minimum, the gas velocity locally becomes sonic, a condition called choked flow that has a choked in the convergent section and the shape of the divergent section also ensures that the direction of the escaping air also known gases is directly backwards, as any sideways component would not contribute to thrust. Compressor nozzle 12 cross-sectional area increases, the gas begins to expand, and the gas flow increases to supersonic velocities where a sound wave will not propagate backwards through the nozzle. Compressor nozzle 12 that are joined intake incoming upstream air to that are joined outlet which air, fluid, or gas flows causing blade 10 movement.

Converging and diverging portions: The converging portion has a greater diameter than the diverging portion. The converging portion has a high capacity and a low velocity. The diverging portion will have a low capacity and a high velocity with a back pressure. The ambient pressure, referred to as lower atmospheric pressure, “back pressure” causes the fluid stream to accelerate. By reducing the pressure of the gases at the exit of the expansion portion, in effect, the molecules leave the outlets at their thermal speed without colliding with other molecules. This is because the molecules are all moving in the same relative direction and at the same speed.

A de Lava with nozzle (or convergent-divergent nozzle, CD nozzle or con-di nozzle) is a tube that is pinched in the middle, making a carefully balanced, asymmetric hourglass shape. In a subsonic flow sound will propagate through the gas. At the “throat”, where the cross-sectional area is at its minimum, the gas velocity locally becomes sonic (Mach number=1.0), a condition called choked flow. In a supersonic de Lava with nozzle: It is used to accelerate a hot, pressurized gas passing through it to a higher supersonic speed in the axial (thrust) direction, by converting the heat energy of the flow into kinetic energy.

A de Laval type nozzle: A nozzle is a shaped tube through which hot fluid flows. At the “throat”, where the cross-sectional area is at its minimum, the gas velocity locally becomes sonic (Mach number=1.0), a condition called choked flow. As the nozzle cross-sectional area increases, the gas begins to expand and the gas flow increases to supersonic velocities where a sound wave will not propagate backwards through the gas as viewed in the frame of reference of the nozzle (Mach number>1.0). This nozzle configuration is called a convergent-divergent, or CD, nozzle.

### BRIEF DESCRIPTION OF THE DRAWINGS

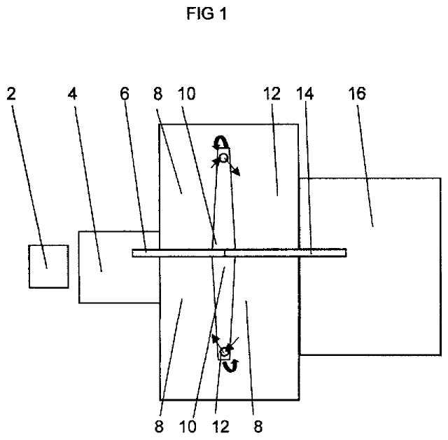

The above and other objects, features and other advantages of the present invention be more clearly understood from the following description taken in conjunction with the accompanying drawings, in which: FIG. 1. A perspective view illustrating: Battery 2, motor 4, motor axis 6, container 8, blade 10, compressor nozzle 12 that are joined intake air flow that are joined outlet air flow, generator axis 14, generator 16.

### SUMMARY

Motor blade generator system also known as known as apparatus: The object of the present invention is to provide a method to increase kinetic energy from an combination of: Battery 2 that remained stationary, battery 2 means to generate electric to motor 4, motor 4 that remained stationary, motor axis 6 is the component of motor 4, motor 4 causes motor axis 6 circular motion, motor axis 6 with means that are joined to blade 10, container 8, container 8 containing portion of motor axis 6 and blade 10 and compressor nozzle 12 and compressor nozzle 12 is the component of blade 10 and containing portion of generator axis 14, compressor nozzle 12 is the component of blade 10, compressor nozzle 12 which that are joined intake that are joined outlet which air, fluid, or gas flows, compressor nozzle 12 causes blade 10 circular rotate motion, compressor nozzle 12 at least two or more, compressor nozzle 12 causes blade 10 circular rotate motion, blade 10 is the component of generator axis 14, generator axis 14 is the component of generator axis 14, generator axis 14 is the component of generator 16, generator 16 means to generate electricity, generator 16 means to generate battery 2.

### TECHNICAL FIELD

Battery 2 that remained stationary, battery 2 means to generate electric to motor 4, motor 4 that remained stationary, motor axis 6 is the component of motor 4, motor axis 6 with means that are joined to blade 10, container 8, container 8 containing portion of motor axis 6 and blade 10 and compressor nozzle 12 and compressor nozzle 12 is the component of blade 10 and containing portion of generator axis 14, compressor nozzle 12 is the component of blade 10, compressor nozzle 12 which that are joined intake that are joined outlet, compressor nozzle 12 at least two or more, blade 10 is the component of generator axis 14, generator axis 14 is the component of generator axis 14, generator axis 14 is the component of generator 16, generator 16 means to generate electricity, generator 16 means to generate battery 2.

### EMBODIMENT: IN DIFFERENT FORMS

While the invention is susceptible to embodiment in many different forms, it will be understood that various modifications may be made to the embodiment disclosed herein. For example, dimensions may vary and are only approximations of a preferred embodiment, and any suitable fasteners may be utilized to operatively connect the various elements described herein. In addition, the nozzle, and its construction may be varied, as would be known in the art.

Likewise, the number and structure of the nozzle, etc. Also, the orientation of the nozzle, for example, they could be at a different angle than illustrated, or be in line with each other, as would be known to those of skill in the art. Therefore, the above description should not be construed as limiting, but merely as exemplifications of a preferred embodiment.

Those skilled in the art will envision other modifications within the scope, spirit, and intent of the invention as shown in the drawings and will be described to herein in detail, specific embodiments thereof with the understanding that the present disclosure is to be considered as an exemplification of the principles of the invention and is not to be limited to the specific embodiments described.

Each one of the examples is provided by way of explanation of the invention, not limitation of the invention. In fact, it will be apparent to those skilled in the art that various modifications and variations can be made in the present invention without departing from the scope or spirit of the invention.

For instance, features illustrated or described as component of one embodiment can be used same component with another other component to yield a still further embodiment.

Thus, it is intended that the present invention covers such modification and variations as come within the scope of the appended claims and their equivalents. Embodiments described with reference to accompanying FIGURES, wherein like reference numbers designate corresponding or identical elements throughout the figures. It should be appreciated that the present invention is not limited to any type or style depicted in FIGURES, for illustrative purposes only. It should be appreciated that the present invention is not limited to any type or style depicted in FIGURE's and is for illustrative purposes only.

### RAMIFICATIONS OF DETAILED DESCRIPTION

Although preferred embodiments have been depicted and described in detail therein, it will be apparent to those skilled in the relevant art that various modifications, additions, substitutions, and the like can be made without departing from the spirit of the invention and these are therefore considered to be within the scope of the invention as defined in the following claims.

Changes could be made without departing from essence present invention, by having other kinds of nozzle with the subsonic de Lava nozzle: Like in determining the shape of the blade with nozzle in the Mach number. Like deflection in the blade and or the nozzle with prescribed geometry that includes inlet and exit nozzle angles, blade line and thickness distribution.

Other change could be having nozzle intake or outlet, placed higher or lower, smaller, or larger, more or less of them on the kinds of blades or nozzle. There are other kinds of convergent-divergent nozzle, or de Laval type nozzle or other kinds of nozzle with having one is a tube that is pinched in the middle, making an a carefully balanced, asymmetric shape.

1. An apparatus comprising: 1 Battery that remained stationary, battery means to generate electric to motor, motor that remained stationary, motor axis is the component of motor, motor axis with means that are joined to blade, container, container containing portion of motor axis and blade and compressor nozzle and compressor nozzle is the component of blade and containing portion of generator axis, compressor nozzle is the component of blade, blade at least two or more, compressor nozzle which that are joined intake that are joined outlet, compressor nozzle at least two or more per blade, blade is the component of generator axis, generator axis is the component of generator, generator means to generate electricity, generator means to generate battery.

2. The apparatus of claim 1 wherein: Motor that remained stationary, motor axis is the component of motor, motor axis with means that are joined to blade, container, container containing portion of motor axis and blade and compressor nozzle and compressor nozzle is the component of blade and containing portion of generator axis, compressor nozzle is the component of blade, blade at least two or more, compressor nozzle which that are joined intake that are joined outlet, compressor nozzle at least two or more per blade, blade is the component of generator axis, generator axis is the component of generator, generator means to generate electricity.

3. The apparatus of claim 1 wherein: Motor that remained stationary, motor axis is the component of motor, motor axis with means that are joined to blade.

4. The apparatus of claim 1 wherein: Container, container containing portion of motor axis and blade and compressor nozzle and compressor nozzle is the component of blade and containing portion of generator axis.

5. The apparatus of claim 1 wherein: Container containing portion of motor axis and blade and compressor nozzle and compressor nozzle is the component of blade and containing portion of generator axis, compressor nozzle is the component of blade.

6. The apparatus of claim 1 wherein: Container, container containing portion of motor axis and blade and compressor nozzle and compressor nozzle is the component of blade and containing portion of generator axis, compressor nozzle is the component of blade.

7. The apparatus of claim 1 wherein: Motor that remained stationary, motor axis is the component of motor, motor axis with means that are joined to blade, container, container containing portion of motor axis and blade and compressor nozzle and compressor nozzle is the component of blade and containing portion of generator axis, compressor nozzle is the component of blade.

8. The apparatus of claim 1 wherein: Blade at least two or more, compressor nozzle which that are joined intake that are joined outlet, compressor nozzle at least two or more per blade, blade is the component of generator axis.

9. The apparatus of claim 1 wherein: Blade is the component of generator axis, generator axis is the component of generator, generator means to generate electricity.

10. The apparatus of claim 1 wherein: Compressor nozzle which that are joined intake that are joined outlet, compressor nozzle at least two or more per blade, blade is the component of generator axis, generator axis is the component of generator.

11. The apparatus of claim 1 wherein: Container, container containing portion of motor axis and blade and compressor nozzle and compressor nozzle is the component of blade and containing portion of generator axis, compressor nozzle is the component of blade, blade at least two or more, compressor nozzle which that are joined intake that are joined outlet, compressor nozzle at least two or more.

12 The apparatus of claim 1 wherein: Compressor nozzle is the component of blade, blade at least two or more, compressor nozzle which that are joined intake that are joined outlet, compressor nozzle at least two or more per blade, blade is the component of generator axis, generator axis is the component of generator, generator means to generate electricity.

13. The apparatus of claim 1 wherein: Compressor nozzle is the component of blade, blade at least two or more, compressor nozzle which that are joined intake that are joined outlet, compressor nozzle at least two or more per blade, blade is the component of generator axis.

14. The apparatus of claim 1 wherein: Compressor nozzle is the component of blade, blade at least two or more, compressor nozzle which that are joined intake that are joined outlet, compressor nozzle at least two or more per blade.

15. The apparatus of claim 1 wherein: Blade is the component of generator axis, generator axis is the component of generator, generator means to generate electricity, generator means to generate battery.
